(19) United States
(12) Patent Application Publication
(10) Pub. No.: US 2026/0018330 A1
(43) Pub. Date: Jan. 15, 2026

(54) HIGH-VOLTAGE SPIRAL VOLTAGE MULTIPLIER

(71) Applicant: Zhejiang Huadian Equipment Testing and Research Institute Co. LTD., Zhejiang (CN)

(72) Inventors: JIANQIN LIN, Zhejiang (CN); JIAMING LIANG, Zhejiang (CN); ZHI LI, Zhejiang (CN); ZHIYAO ZHENG, Zhejiang (CN); CHAOFENG LIN, Zhejiang (CN); HANPENG YANG, Zhejiang (CN); LIANG FENG, Zhejiang (CN); SHENG XIANG, Zhejiang (CN); JIALING LI, Zhejiang (CN); ZIXUAN JING, Zhejiang (CN); SHAOFENG YU, Zhejiang (CN)

(21) Appl. No.: 19/214,346

(22) Filed: May 21, 2025

Related U.S. Application Data
(63) Continuation of application No. PCT/CN2024/139473, filed on Dec. 16, 2024.

(30) Foreign Application Priority Data
Jul. 12, 2024 (CN) 202410931661.X

(51) Int. Cl. H01F 27/32

(52) U.S. Cl. CPC H01F 27/324

(57) ABSTRACT

A high-voltage spiral voltage multiplier includes an outer metal film and an inner metal film which are constructed into a spiral bifilar winding configuration, a first insulating film between the outer metal film and the inner metal film, and a second insulating film between the inner metal film and a further outer metal film adjacent thereto. The outer metal film and the inner metal film are spirally bifilarly wound into N turns of winding, center positions of any two adjacent turns being axially offset by at least a predetermined offset distance.

### CROSS-REFERENCE TO RELATED APPLICATION AND CLAIM OF PRIORITY

The present application is a continuation application to International Application No. PCT/CN2024/139473 with an International Filing Date of Dec. 16, 2024, which claims the benefit of Chinese Patent Application No. 202410931661.X filed on Jul. 12, 2024, at the Chinese Intellectual Property Office, the disclosures of which are incorporated by reference herein in their entirety.

### BACKGROUND

### 1. Field

The subject matter described herein relates to high-voltage pulse generation, and more particularly relates to a high-voltage spiral voltage multiplier.

### 2. Background Art

A high-voltage pulse generator is essential in triggering and controlling a stage-by-stage pulsed power amplification process. To obtain a fast leading-edge high-voltage pulse on the order of hundreds of kilovolts (kV), a pulse capacitor may be leveraged to amplify the output via a pulse transformer, which, however, limits the leading edge due to longer response delay of the ferrite core of the pulse transformer; or, a high-voltage pulse capacitor may be leveraged to discharge directly, which, however, generally requires a plurality of pre-stage pulse generators for stage-by-stage amplification, resulting in longer device trigger delay, higher jitter, and deteriorated device reliability. If a spiral voltage multiplier with an operating voltage at several or tens of KV is leveraged as the high-voltage pulse generator, a fast leading-edge high-voltage pulse on the order of hundreds of kV can be obtained through tens of turns of voltage multiplication.

The high-voltage spiral voltage multiplier is a capacitive energy storage-type high-voltage nanosecond pulse generator, a principle of which is illustrated in FIG. 1. The high-voltage spiral voltage multiplier includes a spirally-wound elongated bifilar winding, the bifilar winding also serving as a primary energy-storage capacitor, a step-up transformer, a secondary energy-storage capacitor, and a transmission line. When the intermediate wire of the bifilar winding is charged to a set voltage Uo, the inner-layer winding and the outer winding have a same voltage amplitude but opposite polarities, so that the voltage at the output end is zero. When the primary switch S is closed, the electromagnetic wave is transmitted to the inner end along the outer end of the long wire, cascading the capacitors formed between adjacent spiral turns. By open-circuiting the inner end, the electromagnetic wave is reflected, when the transmission line of the long wire has its voltage polarity reversed to be identical to the polarity of the transmission line of the outer coil, the voltages are tallied, with the voltage at the output end being nnUo, where n denotes the superimposed voltage efficiency, and n denotes the turn number of winding. This type of spiral voltage multiplier offers benefits such as short system delay, low jitter, and low trigger voltage, which may be applied as a pre-stage trigger unit for a 100 kV high-voltage pulse generator. A high voltage above 100 kVis more demanding on electric insulation. Interlayer creepage insulation is a challenge for the spiral voltage multiplier. Parallel winding, which is a conventional winding manner, has a short creepage distance, which is prone to insulation flashover, leading to device failure and shorter device life. However, a resort to increase the creepage distance alone would result in unsatisfaction of other performance requirements.

### SUMMARY

A high-voltage spiral voltage multiplier according to the present disclosure is provided to overcome drawbacks of a conventional spiral voltage multiplier such as proneness to insulation flashover causing device failure and reducing device life due to a short inter-turn creepage distance.

A technical solution of the present disclosure is set forth infra:
A high-voltage spiral voltage multiplier, including an outer metal film, an inner metal film, a first insulating film, and a second insulating film, the outer metal film and the inner metal film being constructed into a spiral bifilar winding configuration, the first insulating film being sandwiched between the outer metal film and the inner metal film, the second insulating film being sandwiched between the inner metal film and a further outer metal film adjacent thereto, wherein the outer metal film and the inner metal film are spirally bifilarly wound into N turns of winding, center positions of any two adjacent turns being axially offset by at least a predetermined offset distance; an equivalent capacitance between the outer metal film and the inner metal film is adjusted by adjusting parameters of the outer metal film, the inner metal film, the first insulating film, and the second insulating film, a difference between the equivalent capacitance adjusted and a capacitance of a non-offset center position being less than a predetermined threshold.

A conventional parallel winding manner has a shorter insulation distance between two end turns, which is prone to inducing creeping flashover; since the creeping flashover voltage is proportional to the insulation distance, the greater the insulation distance is, the less likely the creeping flashover is induced. The insulation distance refers to a distance of the path along which the creeping flashover likely occurs between the innermost end electrode and the outermost end electrode of the winding structure. In this solution, since the center positions of any two adjacent turns are axially offset by at least a predetermined offset distance, the insulating film between two layers of metal films protrudes outward, which extends the inter-turn creepage distance, resulting in significant increase of the insulation distance between two end turns, increase of the insulation margin, and reduction of potential flashover. Since the thicknesses of the metal film and insulating film are on the order of millimeters, the winding radius is far greater than their respective thicknesses as well as the offset distance therebetween; further, due to malleability or elasticity of the metal film and the insulating film, they satisfy physical requirements of winding according to this solution. Meanwhile, by adjusting the equivalent capacitance between the outer metal film and the inner metal film, this solution prevents reduction of the equivalent capacitance of the winding configuration of the present disclosure over the conventional technology, which would otherwise affect performance or normal operation of the high-voltage spiral voltage multiplier.

In some implementations, the center positions of any two adjacent turns in the N turns of winding are offset in a same direction.

In some implementations, the N turns of winding include an upper half portion and a lower half portion, the upper half portion and the lower half portion including N/2 turns of winding, respectively, center positions of every and any two adjacent turns in the upper half portion being offset in a same direction, center positions of every and any two adjacent turns in the lower half portion being offset in a same direction, a center position of the upper half portion and a center position of the lower half portion being offset in opposite directions.

In some implementations, the N turns of winding include M sections, center positions of every and any two adjacent turns in each section being offset in a same direction, center positions of any two adjacent sections being offset in opposite directions.

In some implementations, the center positions of any two adjacent turns are axially offset by equal predetermined offset distances.

In some implementations, the center positions of any two adjacent turns in the N turns of winding are axially offset by unequal offset distances, and an offset direction between any two adjacent turns is consistent with or opposite to an offset direction between any other two adjacent turns.

In some implementations, an equivalent capacitance between the outer metal film and the inner metal film is determined as:

$$C = \frac{N ε S}{d} = \frac{π N ε L ( {D}_{1} + {D}_{2} )}{2 d}$$

where C denotes the equivalent capacitance, N denotes a number of spiral turns, ε denotes a dielectric constant, S denotes an active area of the metal film, d denotes an inter-turn spacing, L denotes a width of the metal film, D₁ denotes an outside diameter of the spiral bifilar winding configuration, and D₂ denotes an inside diameter of the spiral bifilar winding configuration;
a ratio of the equivalent capacitance to a capacitance of a non-offset center position is determined as:

$$β = 1 - \frac{2 d}{L tan α}$$

where a denotes an angle of inclination;
and the equivalent capacitance is adjusted to be equal to the capacitance of the non-offset center position by increasing width of the metal film, reducing thickness of the insulating film, or using an insulating medium of a higher dielectric constant as per the ratio of the equivalent capacitance.

In some implementations, an equivalent capacitance between the outer metal film and the inner metal film is determined as:

$$C = \frac{N ε S}{d} - \frac{π N ε L ( {D}_{1} + {D}_{2} )}{2 d}$$

where C denotes the equivalent capacitance, N denotes a number of spiral turns, ε denotes a dielectric constant, S denotes an active area of the metal film, d denotes an inter-turn spacing, L denotes a width of the metal film, D₁ denotes an outside diameter of the spiral bifilar winding configuration, and D₂ denotes an inside diameter of the spiral bifilar winding configuration;
a ratio between the equivalent capacitance to a capacitance of a non-offset position is determined as:

$$β = 1 - \frac{π d}{L}$$

the equivalent capacitance is adjusted to be equal to the capacitance of the non-offset center position by increasing width of the metal film, reducing thickness of the insulating film, or using an insulating medium of a higher dielectric constant as per the ratio of the equivalent capacitance.

The present disclosure offers the following benefits: the present disclosure optimizes the spiral winding configuration, increases the insulation distance, and improves the creepage insulation effect. Without a need to add or cancel a component, the present disclosure substantially does not raise the winding difficulty over conventional solutions. Meanwhile, the present disclosure offers a scalability, which allows for flexible adjustment of the offset distance and the offset direction of the winding configuration as per an actual size of the configuration, thereby giving a full play of the insulating effect of the winding configuration, which reduces potential flashover.

### BRIEF DESCRIPTION OF THE DRAWINGS

FIG. 1 is a schematic diagram of a conventional high-voltage spiral voltage multiplier;

FIG. 2 is a structural sectional view of a single-layer structure including an outer metal film, a first insulating film, an inner metal film, and a second insulating film according to the present disclosure;

FIG. 3 is a two-dimensional longitudinal-section view of a conventional winding structure;

FIG. 4 is a two-dimensional longitudinal-section view of a winding structure according to a first implementation of the present disclosure;

FIG. 5 is a two-dimensional longitudinal-section view of a winding structure according to a second implementation of the present disclosure;

FIG. 6 is a two-dimensional longitudinal-section view of a winding structure according to a third implementation of the present disclosure;

FIG. 7 is a two-dimensional longitudinal-section view of a winding structure according to a fourth implementation of the present disclosure;

FIG. 8 is a schematic diagram of increased insulation distance of the winding structure according to the first implementation of the present disclosure over the conventional winding structure;

FIG. 9 is a three-dimensional schematic diagram of a conventional winding structure;

FIG. 10 is a three-dimensional schematic diagram of the winding structure according to the first implementation of the present disclosure.

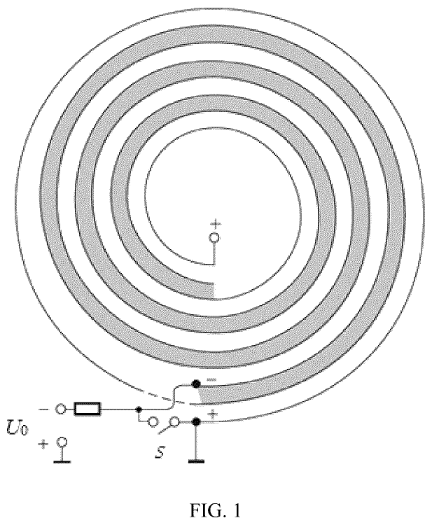

### DETAILED DESCRIPTION OF EMBODIMENTS

To make the objectives, technical solutions, and advantages of the implementations of the disclosure more apparent, the technical solutions in the implementations of the disclosure will be described in a clear and comprehensive manner with reference to the accompanying drawings; it is apparent that the example implementations described herein are only part of the implementations of the disclosure, not all of them. All other implementations derived by a person of normal skill in the art based on the example implementations described herein without exercise of inventive work would fall within the scope of protection of the present disclosure.

It would be understood that, in various implementations of the present disclosure, the values of the serial numbers representing corresponding procedures do not indicate execution sequences; the execution sequences of respective procedures shall be determined based on their functions and inner logic, which shall not constitute any limitation to the execution procedures of the implementations of the present disclosure.

It would be understood that, the terms “comprise” and “have,” as well as any of their variants, intend for a non-exclusive inclusion. For example, a process, method, system, product, or apparatus including a series of steps or units is not limited to the steps or units listed, but may include other steps or units which are not explicitly listed or which are inherent in the process, method, product, or apparatus

It would be understood that, in the present disclosure, the term “plurality” refers to two or more. The term “and/or” only describes an association relationship of associated objects, which indicates that there may exist three relationships, e.g., A and/or B may indicate three circumstances: A individually, or both A and B together, or B individually. The character “/” generally indicates a relationship of “or” between the former and latter associated objects. The term “comprising A, B, and C” or “comprising A, B, C” refers to comprising all of A, B, and C; the term “comprising A, B, or C” refers to comprising one of A, B, and C; the term “comprising A, B and/or C” refers to comply any one, or any two, or three of A, B, and C.

Hereinafter, the technical solution of the present disclosure will be described in detail through specific implementations. The specific implementations described infra may be combined with each other, and same or similar concepts or processes may be omitted in some implementations.

### First Implementation

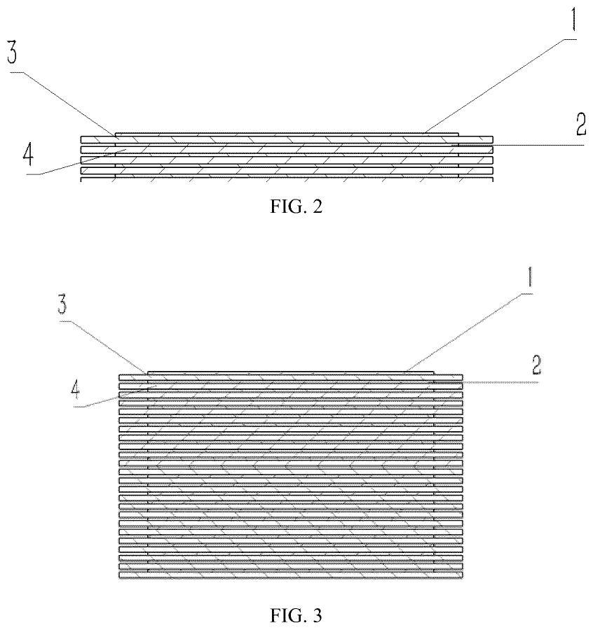

As illustrated in FIG. 2, a high-voltage spiral voltage multiplier includes an outer metal film 1, an inner metal film 2, a first insulating film 3, and a second insulating film 4, the outer metal film and the inner metal film being constructed into a spiral bifilar winding configuration, the first insulating film being sandwiched between the outer metal film and the inner metal film, the second insulating film being sandwiched between the inner metal film and a further outer metal film adjacent thereto. Different from conventional technologies, in this implementations of the present disclosure, the outer metal film and the inner metal film are spirally bifilarly wound into N turns of winding, center positions of any two adjacent turns being axially offset by at least a predetermined offset distance; an equivalent capacitance between the outer metal film and the inner metal film is adjusted by adjusting parameters of the outer metal film, the inner metal film, the first insulating film, and the second insulating film, a difference between the equivalent capacitance adjusted and a capacitance of a non-offset center position being less than a predetermined threshold.

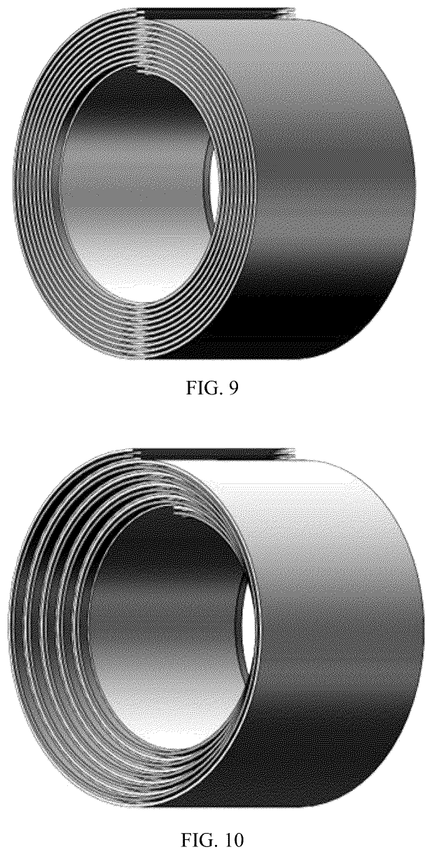

As illustrated in FIGS. 3 and 9, a conventional parallel winding manner has a shorter insulation distance between two end turns, which is prone to inducing creeping flashover; since the creeping flashover voltage is proportional to the insulation distance, the greater the insulation distance is, the less likely the creeping flashover is induced. The insulation distance refers to a distance of the path along which the creeping flashover likely occurs between the innermost end electrode and the outermost end electrode of the winding structure. In this solution, since the center positions of any two adjacent turns are axially offset by at least a predetermined offset distance, the insulating film between two layers of metal films protrudes outward, which extends the inter-turn creepage distance, resulting in significant increase of the insulation distance between two end turns, increase of the insulation margin, and reduction of potential flashover. Since the thicknesses of the metal film and insulating film are on the order of millimeters, the winding radius is far greater than their respective thicknesses as well as the offset distance therebetween; further, due to malleability or elasticity of the metal film and the insulating film, they satisfy physical requirements of winding according to this solution.

To fabricate the high-voltage spiral voltage multiplier, it is needed to first ensure that the insulating film is slightly wider than the metal film so as to guarantee a good insulation between two electrodes, and then the metal film and the insulating film are arranged into a configuration where the outer metal film, the first insulating film, the inner metal film, and the second insulating film are interleaved in sequence, where the inner metal film is wound intimately attached to a columnar insulated inner cylinder; after the overall configuration is successfully wound, the two electrodes at outer ends are connected according to a canonical spiral voltage multiplier connection solution, whereby the creepage distance of the winding configuration is effectively increased.

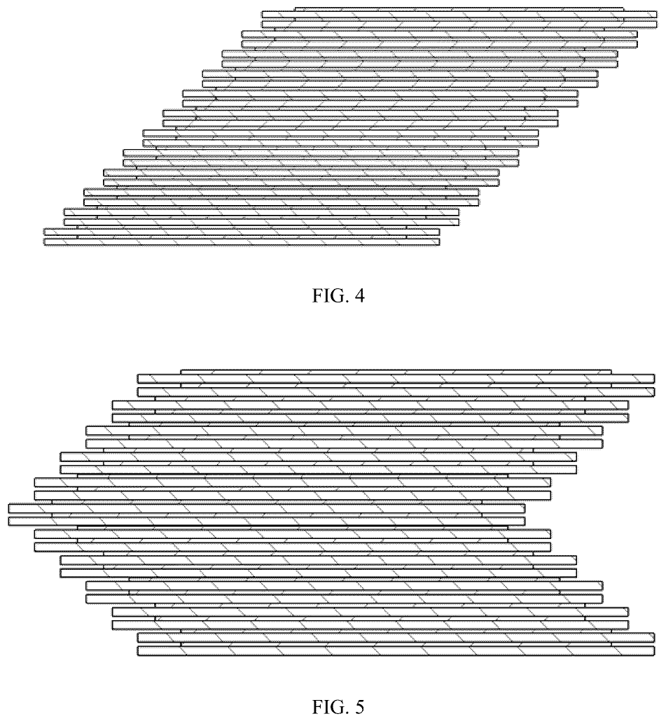

Specifically, as illustrated in FIGS. 4 and 10, in this implementation, the center positions of any two adjacent turns in the N turns of winding are offset in a same direction, and the center positions of any two adjacent turns are axially offset by equal predetermined offset distances. The conventional winding structure has a rectangular longitudinal section, while the configuration in this implementation has a substantially parallelogram longitudinal section, which has a certain inclination angle compared with the rectangle; as illustrated in FIG. 8, l denotes the creeping flashover distance between two ends according to the conventional winding method; by extending the length of creepage insulation to l/sinα times the original length (where α denotes the angle of inclination), the insulation distance is significantly increased. This solution is applicable to a scenario with less turns of winding.

In this solution, the equivalent capacitance between the outer metal film and the inner metal film is determined as:

$$C = \frac{N ε S}{d} - \frac{π N ε L ( {D}_{1} + {D}_{2} )}{2 d}$$

where C denotes the equivalent capacitance, N denotes a number of spiral turns, ε denotes a dielectric constant, S denotes an active area of the metal film, d denotes an inter-turn spacing, L denotes a width of the metal film, D₁ denotes an outside diameter of the spiral bifilar winding configuration, and D₂ denotes an inside diameter of the spiral bifilar winding configuration;
a ratio of the equivalent capacitance to a capacitance of a non-offset center position is determined as:

$$β = 1 - \frac{2 d}{L tan α}$$

the winding structure according to the solution of this implementation can significantly increase the interlayer creepage insulation distance; however, misalignment between adjacent metal films would cause variation of the equivalent capacitance, so that capacitance variation needs to be considered in design, with a compensation measure taken. In this solution, the equivalent capacitance should be designed larger than the conventional solution; therefore, according to the equation of equivalent capacitance, the equivalent capacitance may be adjusted to be equal to the capacitance of a non-offset center position by increasing the width of the metal film, reducing the thickness of the insulating film, or using an insulating medium of a higher dielectric constant.

Second Implementation: a high-voltage spiral voltage multiplier according to this implementation is substantially identical to the first implementation in terms of the principle and the implementation method, but differs from the latter in that the N turns of winding include an upper half portion and a lower half portion, the upper half portion and the lower half portion including N/2 turns of winding, respectively, center positions of every and any two adjacent turns in the upper half portion being offset in a same direction, center positions of every and any two adjacent turns in the lower half portion being offset in a same direction, a center position of the upper half portion and a center position of the lower half portion being offset in opposite directions. As illustrated in FIG. 5, in this implementation, the insulation creepage of the winding is arranged into a V shape; this solution is suitable for a scenario with less turns of winding.

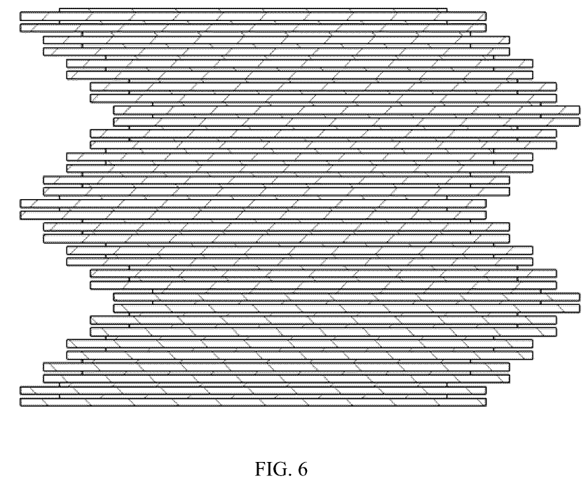

Third Implementation: a high-voltage spiral voltage multiplier according to this implementation is substantially identical to the first implementation in terms of the principle and the implementation method, but differs from the latter in that the N turns of winding include M sections, center positions of every and any two adjacent turns in each section being offset in a same direction, center positions of any two adjacent sections being offset in opposite directions. As illustrated in FIG. 6, in this implementation, the insulation creepage of the winding is arranged into a serrated form due to alternate inclination, and the center s of the overall configuration is offset with a relatively small amount, so that the inter-turn spacing is improved over the first and second implementations; this solution is suitable for a scenario with more turns of winding.

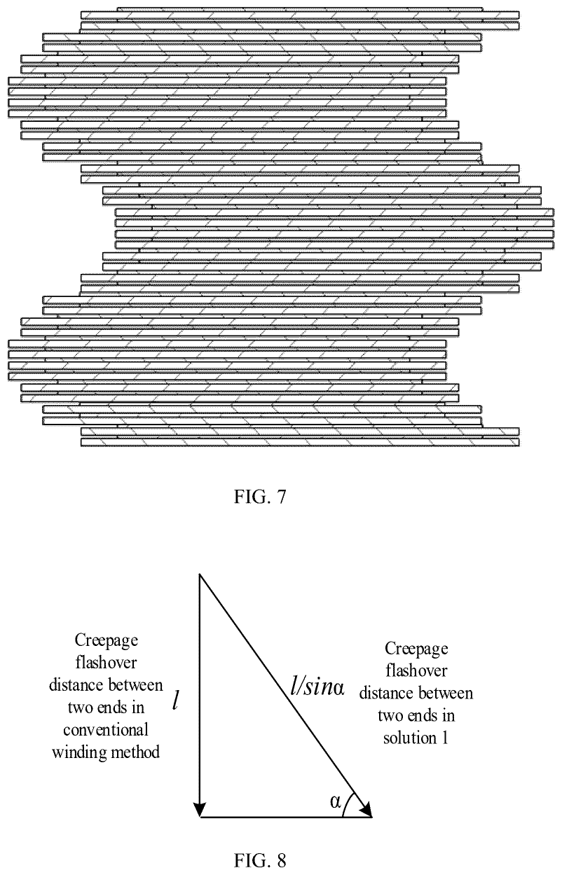

Fourth Implementation: a high-voltage spiral voltage multiplier according to this implementation is substantially identical to the first implementation in terms of the principle and the implementation method, but differs from the latter in that the center positions of any two adjacent turns in the N turns of winding are axially offset by unequal offset distances, and an offset direction between any two adjacent turns is consistent with or opposite to an offset direction between any other two adjacent turns. As illustrated in FIG. 7, in this implementation, the insulation creepage of the winding is arranged into a wave form; as estimated according to a sinusoid, when the length of creepage insulation increases to π/2 times the original length, the center of the overall configuration is offset with a relatively small amount, and the inter-turn spacing is improved over the first implementation and the second implementation; this solution is suitable for a scenario with more turns of winding.

In this solution, the equivalent capacitance between the outer metal film and the inner metal film is determined

$$C = \frac{N ε S}{d} - \frac{π N ε L ( {D}_{1} + {D}_{2} )}{2 d}$$

where C denotes the equivalent capacitance, N denotes a number of spiral turns, ε denotes a dielectric constant, S denotes an active area of the metal film, d denotes an inter-turn spacing, L denotes a width of the metal film, D₁ denotes an outside diameter of the spiral bifilar winding configuration, and D₂ denotes an inside diameter of the spiral bifilar winding configuration;
a ratio of the equivalent capacitance to a capacitance of a non-offset center position is determined as:

$$β = 1 - \frac{π d}{L}$$

in this solution, the equivalent capacitance should be designed greater than the conventional design; therefore, according to the equation of equivalent capacitance, a larger width of the metal film, a smaller thickness of the insulating film, and a higher dielectric constant of the insulating medium may be designed such that the equivalent capacitance is equal to the capacitance of a non-offset center position.

The solution of the present disclosure offers scalability; the winding may be arranged as per actual needs to enhance creepage insulation strength, including, but not limited to the inclined, V-shaped, serrated (W-shaped), and wave-form configurations described supra.

In view of the above, the present disclosure optimizes the spiral wire winding structure, increases the insulation distance, and improves creepage insulation effect.

Without a need to add or cancel a component, the present disclosure substantially does not raise the winding difficulty over conventional solutions. Meanwhile, the present disclosure offers a scalability, which allows for flexible adjustment of the offset distance and the offset direction of the winding configuration as per an actual size of the configuration, thereby giving a full play of the insulating effect of the winding configuration, which reduces potential flashover.

Those skilled in the art may understand, for the convenience and brevity of description, the partitions of various functional modules in the implementations described supra are only exemplary; in actual applications, the functions may be performed by other functional modules as needed, i.e., the internal structure of a specific apparatus is partitioned into different functional modules to perform all or part of the functions described supra.

It should be understood that, the structures and methods disclosed in the example implementations of the present application may also be implemented otherwise. For example, the structural implementations described supra are only schematic. For example, partition of modules or units is only a logic functional partition, while other partition manners are also possible in actual implementations. For example, a plurality of units or components may be combined or integrated to another structure, or some features may be omitted or not executed. Additionally, the mutual coupling, or direct coupling, or communication as revealed or discussed may be implemented via some interfaces, and the indirect coupling or communication within the structure or between the units may be implemented electrically, mechanically, or in other manners.

The units illustrated as discrete parts may be, or may not be, physically separated; a part revealed as a unit may include one physical unit or a plurality of physical units, i.e., it may reside at one place, or may be distributed to a plurality of different places. Some or all of the units may be selected to fulfill the objectives of the solutions of these implementations according to actual needs.

What have been described above are only example implementations of the present disclosure. However, the scope of protection of the disclosure is not limited thereto. Any modification or substitution easily contemplated by those skilled in the art within the technical scope disclosed herein shall fall within the scope of protection of the present disclosure. Therefore, the scope of protection of the present disclosure shall refer to the scope of protection limited in the appended claims.

What is claimed is:

1. A high-voltage spiral voltage multiplier comprising:
an outer metal film;
an inner metal film;
a first insulating film; and
a second insulating film,
wherein the outer metal film and the inner metal film are constructed into a spiral bifilar winding configuration,
the first insulating film is sandwiched between the outer metal film and the inner metal film,
the second insulating film is sandwiched between the inner metal film and a further outer metal film adjacent thereto,
wherein the outer metal film and the inner metal film are spirally bifilarly wound into N turns of winding, center positions of any two adjacent turns being axially offset by at least a predetermined offset distance,
an equivalent capacitance between the outer metal film and the inner metal film is adjusted by adjusting parameters of the outer metal film, the inner metal film, the first insulating film, and the second insulating film, a difference between the equivalent capacitance adjusted and a capacitance of a non-offset center position being less than a predetermined threshold.

2. The high-voltage spiral voltage multiplier according to claim 1, wherein the center positions of any two adjacent turns in the N turns of winding are offset in a same direction.

3. The high-voltage spiral voltage multiplier according to claim 1, wherein the N turns of winding comprise an upper half portion and a lower half portion, the upper half portion and the lower half portion comprising N/2 turns of winding, respectively, center positions of every and any two adjacent turns in the upper half portion being offset in a same direction, center positions of every and any two adjacent turns in the lower half portion being offset in a same direction, a center position of the upper half portion and a center position of the lower half portion being offset in opposite directions.

4. The high-voltage spiral voltage multiplier according to claim 1, wherein the N turns of winding comprise M sections, center positions of every and any two adjacent turns in each section being offset in a same direction, center positions of any two adjacent sections being offset in opposite directions.

5. The high-voltage spiral voltage multiplier according to claim 1, wherein the center positions of any two adjacent turns are axially offset by equal predetermined offset distances.

6. The high-voltage spiral voltage multiplier according to claim 1, wherein the center positions of any two adjacent turns in the N turns of winding are axially offset by unequal offset distances, and an offset direction between any two adjacent turns is consistent with or opposite to an offset direction between any other two adjacent turns.

7. The high-voltage spiral voltage multiplier according to claim 5, wherein an equivalent capacitance between the outer metal film and the inner metal film is determined as:
$$C = \frac{N ε S}{d} - \frac{π N ε L ( {D}_{1} + {D}_{2} )}{2 d}$$
where C denotes the equivalent capacitance, N denotes a number of spiral turns, ε denotes a dielectric constant, S denotes an active area of the metal film, d denotes an inter-turn spacing, L denotes a width of the metal film, D₁ denotes an outside diameter of the spiral bifilar winding configuration, and D₂ denotes an inside diameter of the spiral bifilar winding configuration;
a ratio of the equivalent capacitance to a capacitance of a non-offset center position is determined as:
$$β = 1 - \frac{2 d}{L tan α}$$
where α denotes an angle of inclination;
and the equivalent capacitance is adjusted to be equal to the capacitance of the non-offset center position by increasing width of the metal film, reducing thickness of the insulating film, or using an insulating medium of a higher dielectric constant as per the ratio of the equivalent capacitance.

8. The high-voltage spiral voltage multiplier according to claim 6, wherein an equivalent capacitance between the outer metal film and the inner metal film is determined as:
$$C = \frac{N ε S}{d} - \frac{π N ε L ( {D}_{1} + {D}_{2} )}{2 d}$$
where C denotes the equivalent capacitance, N denotes a number of spiral turns, ε denotes a dielectric constant, S denotes an active area of the metal film, d denotes an inter-turn spacing, L denotes a width of the metal film, D₁ denotes an outside diameter of the spiral bifilar winding configuration, and D₂ denotes an inside diameter of the spiral bifilar winding configuration;
if the winding is arranged to form a wave-shaped insulating creepage, a ratio between the equivalent capacitance to a capacitance of a non-offset position is determined as:
$$β = 1 - \frac{π d}{L}$$
and the equivalent capacitance is adjusted to be equal to the capacitance of the non-offset center position by increasing width of the metal film, reducing thickness of the insulating film, or using an insulating medium of a higher dielectric constant as per the ratio of the equivalent capacitance.
